(19) United States
(12) Patent Application Publication
(10) Pub. No.: US 2007/0194578 A1
(43) Pub. Date: Aug. 23, 2007

(54) Self latching device

(75) Inventors: Malcolm David Boosey, Wellington (NZ); Martyn Walter Goodwin Collings, Wellington (NZ)

Correspondence Address: Blakely Sokolof Taylor & Zafman, 12400 Wilshire Boulevard 7th Floor, Los Angeles, CA, 90025, US

(73) Assignee: ASSA ABLOY NEW ZEALAND LIMITED, ALBANY, AUCKLAND (NZ)

(21) Appl. No.: 10/589,993

(22) PCT Filed: Feb. 16, 2005
(86) PCT No.: PCT/NZ05/00018

§ 371 Date: Aug. 18, 2006

(30) Foreign Application Priority Data
Feb. 18, 2004 (NZ) 531205

(51) Int. Cl. E05C 19/16

(52) U.S. Cl. 292/251.5

(57) ABSTRACT

A self latching device for self-latching a sliding closure such as a window sash. The device includes a latch member (17) which is moveable between a latching position and a non-latching position. The latch member (17) when in the latching position is engaged with a strike (42). A biasing element (23) biases the latch member (17) into one of the latching and non-latching positions. A magnetic element (43) is provided for moving the latch member (17) into the other of the latching and non-latching positions. In one form the magnetic element (43) is associated with the strike (42) and a magnet element (33) is associated with the latch member (17). The magnets are preferably permanent magnets (33 and 43). A user accessible slider (26) coupled by a coupler (34, 35) to magnet slider (31) enables the magnet element (33) to be temporarily moved away from the magnetic element (43) to enable the latch member (17) to retract from the strike (42).

### BACKGROUND TO THE INVENTION

This invention relates to a self-latching device and in particular a device for self-latching a sliding closure such as a window sash or door.

Double hung windows consist generally of two sashes, one rear (upper) and one front (lower). Each sash has its own vertical track in which to slide thereby allowing the sashes to traverse vertically, and overlap each other to provide the desired opening configuration. Each of the sashes is balanced by counterweight arrangements generally located within the mullions on each side of the sash. The counterweights enable the sash to remain stationary in a desired adjusted vertical position.

Windows of this type, by design, must have the sash channel in which the sash is located constructed wider than the maximum width of the sash to provide clearance. This is to enable the sash to move freely in the vertical direction within its frame without impediment or an undue amount of friction. The sash clearance required potentially results in the sash moving laterally to a degree that known fasteners can become disengaged.

It is also known to arrange the double hung window such that the sash can be tilted forward into the room to facilitate cleaning. Therefore, latches that are attached to the sash may be damaged if they protrude beyond the edge of the sash.

Whilst there are many different double hung window designs, the general principle of operation is typical.

Double hung windows as traditionally manufactured can result in heavy sashes especially when the size of the sash is large. Due to the popularity of these types of windows for use in new buildings, and for the retrofitting and replacement of double hung windows in aged buildings, double hung windows are now manufactured utilising contemporary techniques and methodology. The resulting double hung window units have generally lighter sashes, the movement of which is smooth and consistent.

To provide an element of security, the double hung sashes are locked by a generally single latching device located at the junction between the edges of the front (lower) and rear (upper) sashes.

Traditionally various methods of latching devices have been used on double hung windows. One method is that of using manual latches consisting of two sections, a keeper or strike and a latching element. Typically, the movable latching element is affixed to the top edge of the front (lower) sash, whilst the strike is affixed to the lower edge of the rear (upper) sash. In order for the latch to operate correctly, the two sections must align correctly. Thus with this type of sash lock, there is provided one point of locking the window. This type of latch relies on the latching element and strike being adjacent each other in order for the keeper to latch. Therefore, it does not accommodate lateral movement of the sash.

Another method of securing the window is by use of a self-latching sash latch. Self-latching latches have become commonly used for sliding and single hung windows, however, when these are applied to double hung windows, they do not work reliably. If a self latching latch is to be used as a primary latching device on a double hung window, and the latch is mounted to the front (lower) sash, when the sash is moved to the closed position it may not latch. This is due to the rear (upper) sash being free to move and therefore can be pushed down as well, thereby leaving the window still open and unlatched. The rear.(upper) sash has the strike attached to it. The strike must remain fixed relative to the moving latch for it to self-latch. The only way a user may get a self latching latch of this type to operate correctly when used on a double hung window is to push the rear (top) sash to the closed position, holding it in position, while shutting the bottom (front) sash.

There are a number of different kinds of self-latching latch for use with double hung windows, and they have inherent disadvantages. A disadvantage of some devices is that it is required to pull a lever or actuation device and hold it in the open position until such time that the sash has been moved away from the strike.

Another disadvantage can arise when a sash lock is placed on the top edge of the upper sash. This can cause the lock to be difficult to reach and therefore operate. Also a visual indication of the status of the lock cannot be performed or may be difficult as the latch is high and out of normal sight.

A further disadvantage is that in order for the self-latching device to operate, the top sash must be held stationary and in the closed position, whilst the lower sash is closed. In aged buildings where the sash counterweights have perished, this results in a potentially very heavy top sash that must be held in position. A potentially dangerous situation therefore arises for a person of limited strength to perform this operation.

### SUMMARY OF THE INVENTION

It is thus an object of the present invention to provide a self-latching device which overcomes one or more of the disadvantages of known devices of this type or at least provides the public with a useful choice.

According to one broad aspect of the invention there is provided a self latching device including a latch member moveable between a latching position and a non latching position, the latch member when in the latching position being engaged with a strike, biasing means to bias the latch member into one of said latching and non-latching positions and magnetic means for moving the latch member into the other of said latching and non-latching positions.

Preferably, the magnetic means is a magnet associated with the strike and a magnet associated with the latch member. The magnets are preferably permanent magnets.

According to a preferred form of the invention, one magnet is fixed in position and the other is moveable. Preferably, the magnet associated with the latch member is moveable. It is preferably moveable in a direction transverse to the direction, which the latch member moves between the latching and non-latching positions.

In a preferred form, the latch device includes moving means for moving the moveable magnet. Preferably, there is provided retention means for temporarily retaining the moveable magnet following movement thereof by the moving means.

Preferably, a user accessible slider mechanism is coupled to the moving means. The slider mechanism can include an engagement element to engage with the latch member and move the latch member against the biasing effect of the biasing means. The biasing means can be a spring, which biases the latch member to the non-latching position.

The slide mechanism can include a user accessible actuating element, which is moveable to unlatch the latch, the actuating element being moveable in the direction in which a closure element, such as a window, is moveable toward an open position.

According to one embodiment of the invention, there is provided a self-latching device of a construction that is attachable to the vertical side of a sliding sash of a window. When the sash is moved to its closed position the latch device self actuates under the action of the magnetic means, thereby locking the sash into the closed position. Preferably, a latching device is attached to or mounted with each vertical side of the hung sash.

According to a second broad aspect of the invention there is provided a window sash mounted for vertical sliding movement in a frame the sash including vertical side elements in each of which is located a self latching latch device when has a latch member movable between a latching position and a non-latching position the latch member when in the latching position being engaged in a strike located with a portion of the frame which is adjacent the vertical side element of the sash, and moving means for moving the latch member into engagement with the strike when the sash has moved to a position where latching of the sash is to occur.

Preferably the latching device includes an operating element which is, in use, moveable by a person moving the sash from a latched position to effect movement of the latch member to its non-latching position, the operating element being movable in a direction which corresponds to the direction in which the sash is to move away from the latched position.

In the preferred embodiment the latch member is moved into the latching position by attraction between two magnetic elements, one mounted with the strike and the other with the latch member. The latching device further includes means for causing a shearing action between the magnetic elements to occur whereby the latch member can be moved to the non-latching position. Preferably one magnetic element is movable to a position where it is repulsed by the other magnetic element and thereby driven into a retaining means.

### BRIEF DESCRIPTION OF THE DRAWINGS

In the following more detailed description of the invention according to preferred embodiments, reference will be made to the accompanying drawings in which:

FIG. 1 is a perspective view of the self-latch device from the front left side,

FIG. 2 is a bottom plan view of the self-latching device,

FIG. 3 is top plan view of the self-latching device,

FIG. 4 is a left elevation of the self-latching device,

FIG. 5 is a right elevation of the self-latching device,

FIG. 6A-6F illustrates the action of the self-latching device in response to both user input and the position of the window,

FIG. 7 is an exploded view of the self-latching device,

FIG. 8 is a further exploded view but viewed in an opposite direction to that of FIG. 7,

FIG. 9 is an exploded view of a second embodiment of the invention,

FIG. 10 is an assembled perspective view of the second embodiment,

FIG. 11 is a perspective view of the second embodiment installed in the sash section of a window, the frame section also being illustrated,

FIG. 12 is a perspective view from above of a further form of the strike,

FIG. 13 is a perspective view from beneath the strike shown in FIG. 12,

FIG. 14 is an exploded view of the strike as shown in FIGS. 12 and 13,

FIG. 15 is an exploded view of the strike of FIGS. 12 to 14 but from a different direction, and

FIG. 16 is a rear perspective view of the strike of FIGS. 12 to 15 .

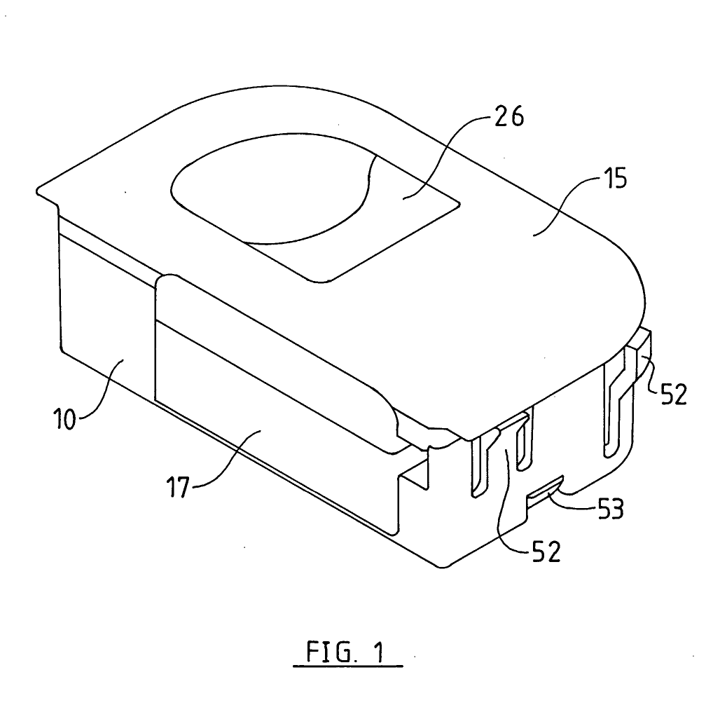

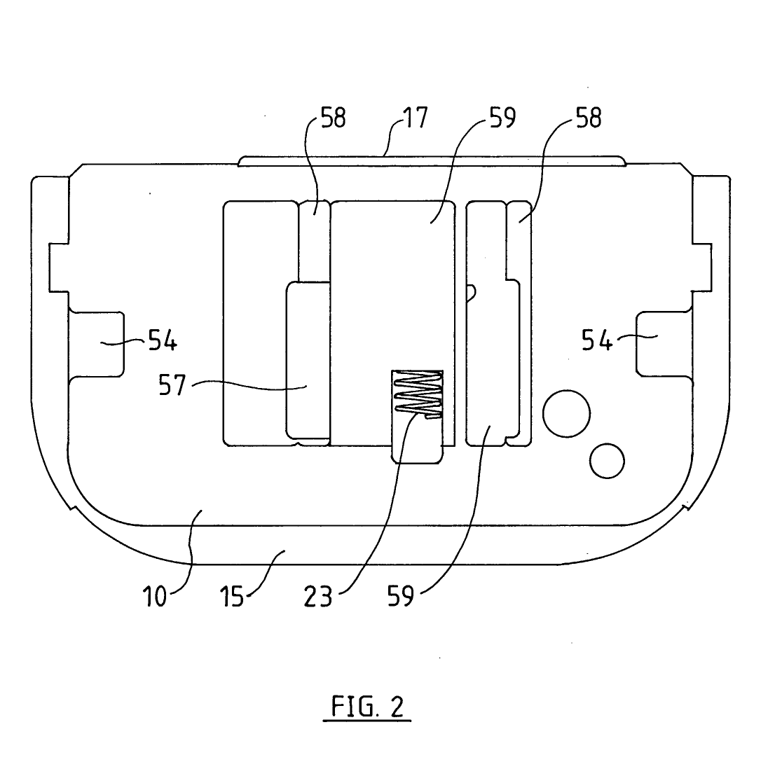

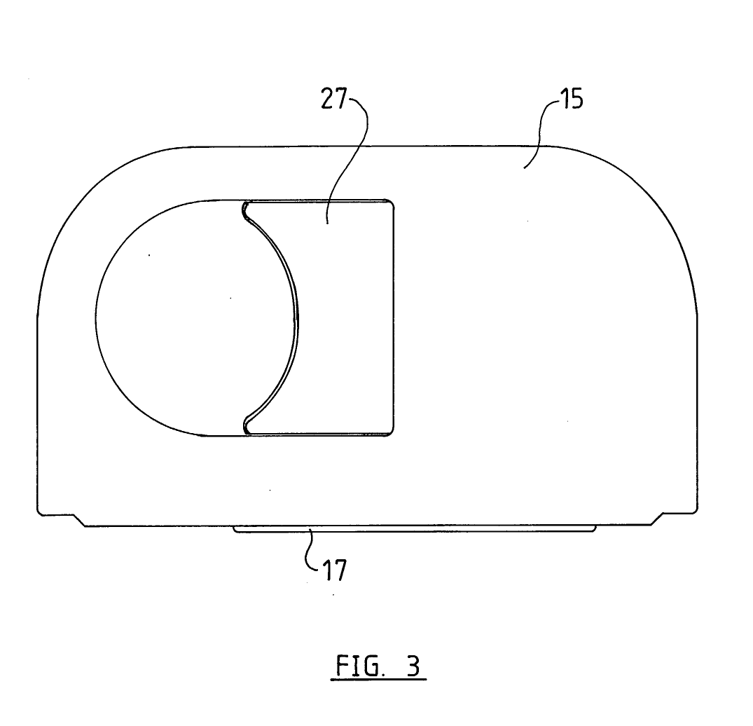

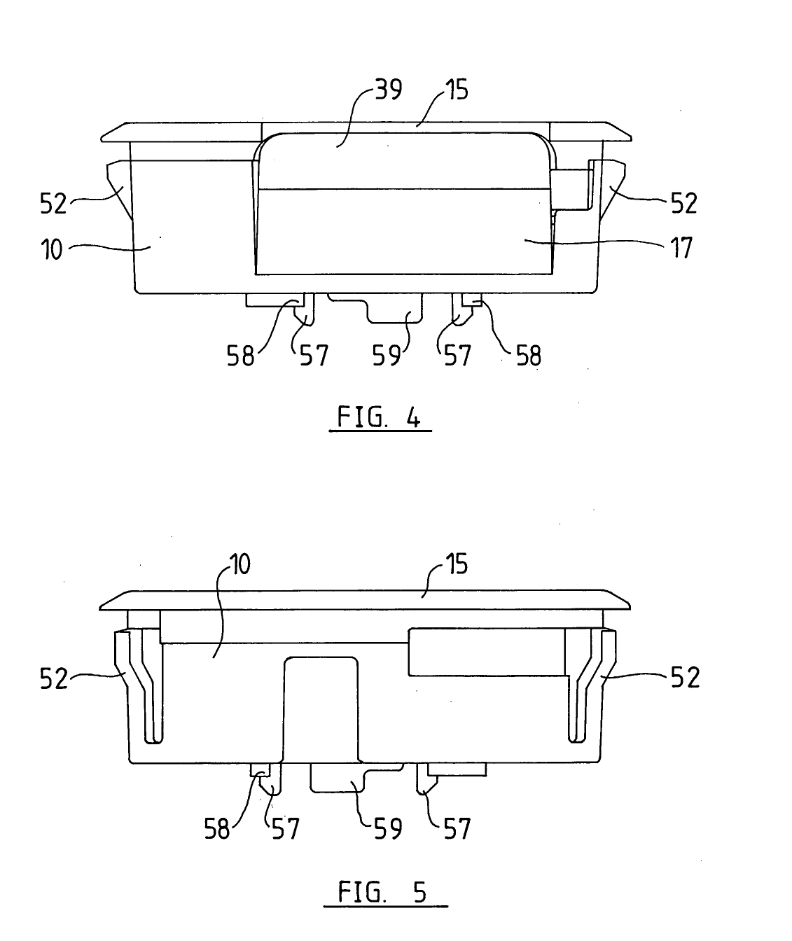

### DETAILED DESCRIPTION OF PREFERRED EMBODIMENTS

As shown in the drawings the self-latching device consists of multiple components contained by body 10 and cover 15. The body 10 is of a generally rectangular shape. The corners 11 of the non-latching side 12 of the body 10 are preferably rounded to accommodate the curved corners of the routed aperture formed in the sash section of a window to accept body 10.

A rectangular cut out 13 is provided in the latching side 14 of body 10. Locking bolt 17 is slidingly located within cut out 13.

The cover 15 which fits over the open top of body 10 is of a generally rectangular shape. In the preferred form it clips to body 10. Cover 15 is larger than body 10, and therefore its periphery extends over the end and side walls of body 10.

Button 26 slides within cover 15. The button 26 is of generally rectangular shape and includes a tongue 28 extending from a finger engagement portion 27. The finger engagement portion is concave in profile to provide both comfort to the user and for aesthetic appeal. The underside of portion 27 of button 26 protrudes below the underside face of tongue 28. The tongue 28 contains a cylindrical recess 29 into which a return spring 30 is located.

A magnet slider 31 is driven by movement of button 26. A rectangular slot 32 with rounded ends is provided in slider 31. A spigot 35, which projects from a disk 34, engages in slot 32. One end of slider 31 has a protrusion 45, which is used to move permanent magnet 33 (as herein described) during operation of the device.

Disk 34 is circular in shape and has a second spigot 35a projecting from the same side as spigot 35. A cylindrical shaft 36 projects from the other side of disk 34. The second spigot 35a slidingly engages in one of the pair of slots 26a of button 26. The particular slot 26a in which spigot 35a engages depends on the handing of the latching device.

The locking means of the self-latching device is by bolt 17. Bolt 17 is generally L shaped in profile. The bolt 17 is provided with an elongate recess 37 along which a permanent magnet 33 of cylindrical profile can move, e.g. slide. At one end of elongate recess 37 there is provided a slightly angled recess 37a into which magnet 33 may be pushed by magnetic repulsion. This prevents magnet 33 moving back toward the other end of elongate recess 37. This creates a detent action as will hereinafter be apparent.

A strike 42 is formed as a separate component, but is required for the correct operation of the self-latching device. Strike 42 is formed by a shaped housing into which the leading or projecting end of bolt 17 is engageable. It will be apparent to those skilled in the art that the profile of the strike 42 may take different forms to allow integration into window mullions of different profiles or sections.

Located within strike 42 is a magnetic element 43, which is generally cylindrical in shape. The magnet 43 is fixed in position in strike 42. Preferably magnet 43 is a permanent magnet. The magnet 43 is conveniently located in one of two separate pockets 42a. The two pockets are provided so that the strike is non-handed, ie. the appropriate pocket is selected at the time by the person installing the latching device.

In use, body 10 of the self-latching device may be affixed to the face of a vertical sliding window sash, but preferably is located in an opening formed in the vertical section of the sash. In this way, cover 15 is mounted flush on the vertical section. Strike 42 is rebated into the window mullion, in a position, which will oppose the location of the self-latching device when the sash is in the closed position.

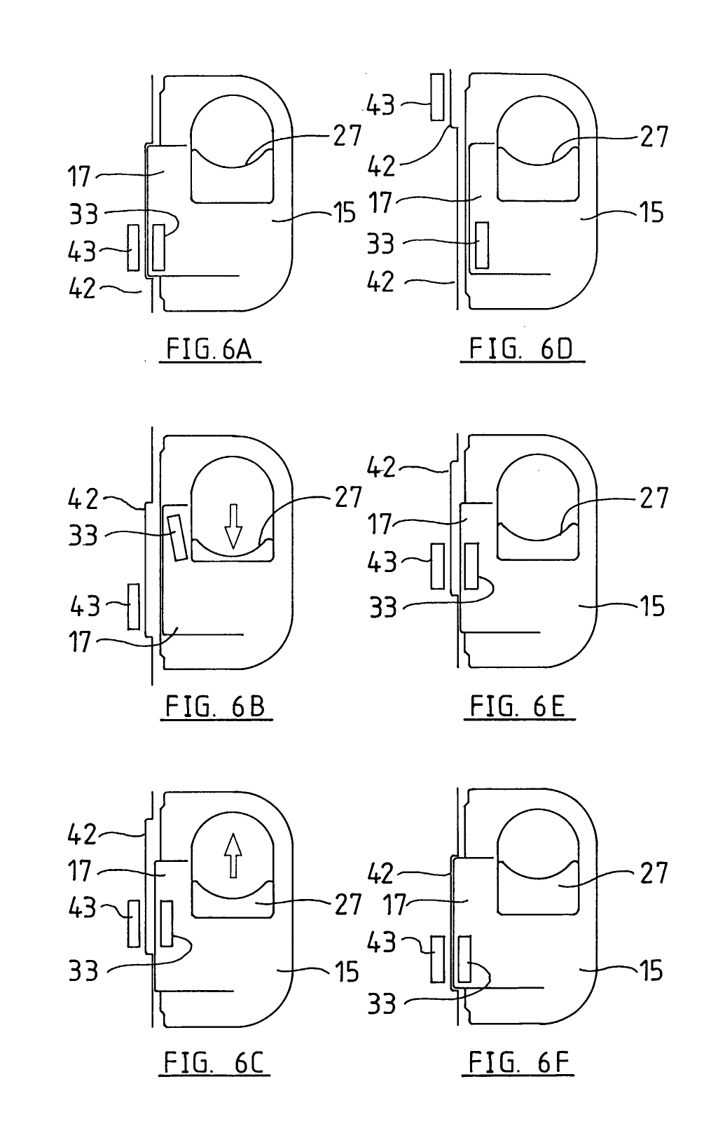

FIG. 6A illustrates the self-latching device and the strike when the window sash is in the closed position. Attraction of magnets 33 and 43 (which are aligned face to face) overcomes the biasing force applied by spring 23 to bolt 17, thereby causing the projecting end of bolt 17 to engage in the strike 42.

To unlatch the latch, thereby allowing the sash to be opened, the user applies a pulling force with his/her finger on finger portion 27, in the direction as indicated in FIG. 6B. The force moves button 26 in the direction in which the sash is going to move to an open position. Thus the users application of force can not only activate the latch but also be used to move the sash to an open position.

In response to the force applied by the user to button 26, button 26 moves longitudinally within body 10 against the return force of spring 30. Slot 26a of button 26 is in engaging contact with spigot 35a of disk 34. As button 26 moves within body 10, the spigot 35a moves in unison, thereby causing disk 34 to rotate in the clockwise direction.

A third spigot 35b on the underside of disk 34 acts against the flat surface 44a of recess 44, on locking bolt 17, thereby pushing against this face and providing a force to move locking bolt 17 inwards and away from the strike. Accordingly this positive moving force ensures that any frictional or preloaded force(s) acting on the bolt 17 (which may otherwise prevent or restrain the bolt from moving) are overcome.

As disk 34 rotates, slider 31 coupled to spigot 35 is moved laterally. The protrusion 45 on slider 31 pushes magnet 33 along recess 37 until the magnet engages in the angled recess 37a in the end of the recess 37. Magnet 33 is forced into the recess 37a by the force of magnetic repulsion (refer FIG. 6B). As there is no magnetic attractant force attracting locking bolt 17 toward strike 42, spring 23 thereby biases locking bolt 17 into it's retracted position. The locking mechanism is, in this position, unlatched.

The user may now move, and therefore open the window sash. The button 26 remains down in the unlatched position until such time as the window sash is moved.

As the window sash is moved, button 26 moves laterally from its unlatched inward position, to the latched position. As the window sash has been moved, strike 42 and locking bolt 17 are no longer aligned. The locking bolt 17 therefore cannot relatch in the strike 42 until the window is returned to its closed position. Magnet 33 is attracted to magnet 43 in the strike, and is moved out of recess 37a to move freely within recess 37 (refer to FIG. 6C).

Once the window sash, and therefore the self-latching device has been moved sufficiently clear of the strike there is no magnetic extension force on locking bolt 17 (refer FIG. 6D). Spring 23 provides a force to withdraw locking bolt 17 into body 10. In this position the locking bolt 17 is completely concealed within body 10. Thus when the sash is of a “tilt to clean” construction the locking bolt cannot contact the frame when the sash is tilted to the cleaning position.

Upon closing of the window sash, the self-latching device once again moves into proximity of the strike 42 and magnets 43 and 33 become close thereby creating a magnetic attractant force (refer to FIG. 6E). Magnet 33 moves freely within recess 37 in locking bolt 17, therefore the strength of the attractant force remains constant as both magnets remain opposite one another. As the magnetic force is greater than the return force provided by spring 23, locking bolt 17 moves outward from body 10 toward the strike (FIG. 6E) and slidably contacts with the frame

Once the window sash moves into the closed position, locking bolt 17 aligns with the opening in strike 42 so that the bolt 17 under the attraction of magnets 33 and 43 engages within strike 42 (refer to FIG. 6F). The self-latching action is thus completed thereby locking the sash in the closed position.

Because of the arrangement of the moving and fixed magnets and the detent action arising from the magnets being repulsed by the fixed magnet into recess 37a (after “shearing” of magnets has occurred the latch is effectively intelligent. This is because the construction results in the latching device “knowing” in which sliding direction the sash is moved.

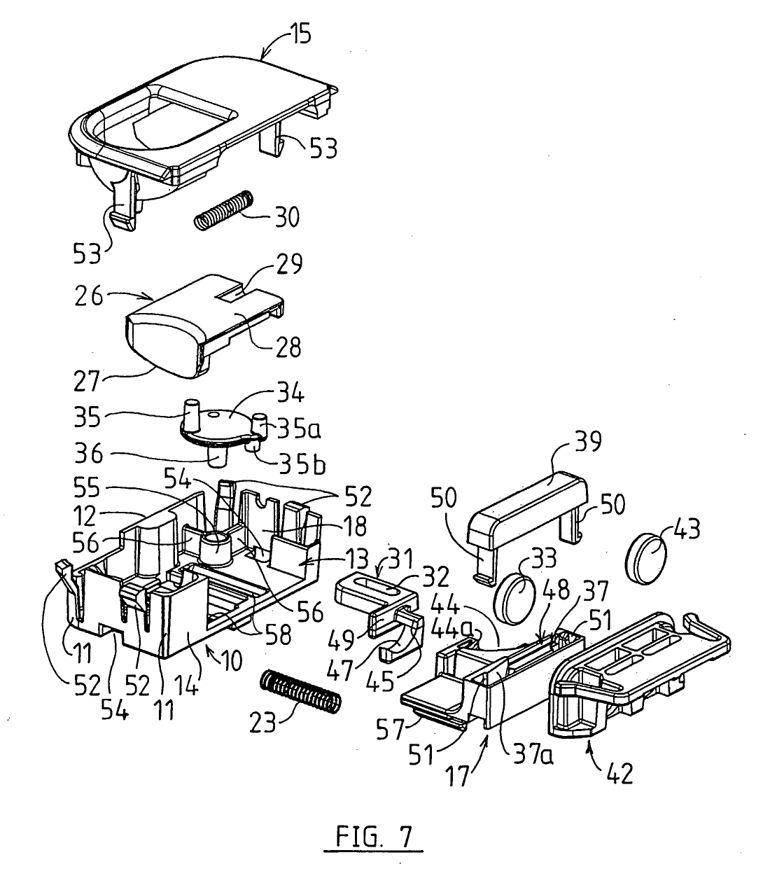

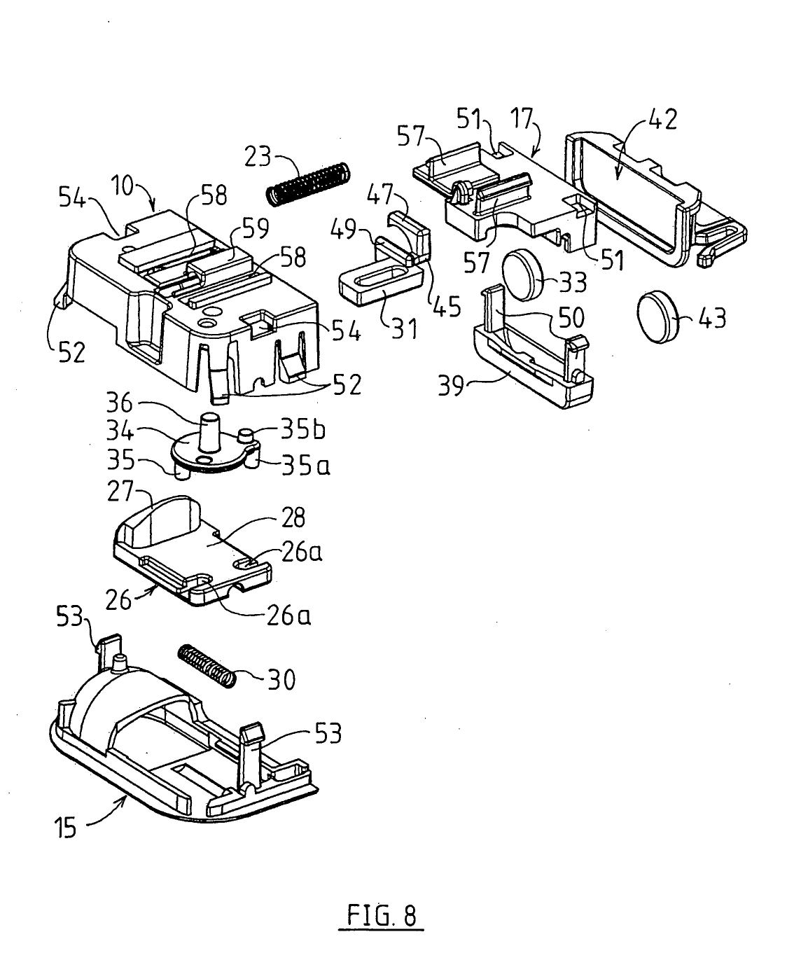

In a preferred embodiment the protrusion 45 on the slider 31 includes a scoop 47 (see FIGS. 7 and 8) to push the magnet 33 along the recess.

FIG. 7 better illustrates a track and guide 48 formed in bolt 17 adjacent and parallel to recess 37 in which engages an edge of flange 49 of the slider 31. This aids in guiding the lateral movement of slider 31.

As can be seen, a cover 39 fits onto bolt 17 and encloses recess 37. The cover includes a pair of clips 50, which snap fit into pockets 51 in the leading end of bolt 17.

Cover 15 has clip legs 53, which snap lock into pockets 54 in the floor 16 of body 10. The body 10 also incorporates a plurality of clips 52. These, plus the overlay of the cover 15 enable body 10 to be snap fitted into an opening in the vertical section of the sash.

FIG. 7 shows the boss form 55 into which stem 36 of disk 34 engages to rotatably locate the disk. This boss form 53 projects from floor 16 and is connected by webs 56 to the end 18 and side 12 of the body 10.

Referring to FIG. 8 the underside of bolt 17 is shown to include a pair of hooked protrusions 57. These slidingly engage in a snap fit into the pair of elongate slots 58 in the floor 16 of body 10. Between the slots 58 is formed a tunnel 59 or like locating feature for spring 23.

It will be apparent to those skilled in the art that there are window sashes of different configurations that the self-latching device can be successfully applied to.

The present invention provides an easy to use self-latching device that can be located on the side faces of a window sash within easy reach of a user. The location is completely flexible. As the latch is in the users view the user can obtain visual confirmation that the device is unlatched and the sash has not been moved from the fully closed position.

Once the self-latching device has been unlatched, the button remains in the inward position indicating to the user that the device is unlatched. The self-latching device relatches upon closure of the window sash.

The mechanism provides a convenient pocket to be used as a finger pull and activates in the same direction as the window moves. Thus, there is one action or movement to unlatch and move the window to an open position.

The self-latching device is unaffected by lateral movement of the window sash. The locking bolt is designed to extend a greater distance from the body as would normally be required, thereby allowing a margin of movement between sash and mullion to occur without risk of the locking bolt releasing from the strike.

The latches are also detentable due to the magnetic concept. This means they can be unlatched individually, and they stay unlatched so the window can be moved by holding any location on the sash (the latch does not need to be held while the sash is moved away from the strikes). The buttons stay down when activated showing that the latch is unlocked and reset automatically when the window is opened.

The self-latching device will therefore provide the user with an effective device that is capable of self-latching double hung windows, whilst allowing the user easy access and visual feedback on the status of the device.

By having a latching device at each vertical side of the sash two parts of latching is achieved. This provides good security. However, by having multiple strikes in the window frame the sash can be moved from one locked position to another thereby allowing a ventilation gap to be created.

The invention is open to modification as will be apparent to those skilled in the art. For example in an alternative embodiment the movable magnet could be in the strike and the fixed magnet in the bolt. Also the fixed magnet could be a controllable electromagnet. This could provide advantages such as permitting automatic unlatching of the latching device upon a control unit sensing or reacting to the sensing of a safety issue such as fire.

While one means of providing translation of movement of button 26 into movement of bolt 17 has been disclosed other arrangements are possible. For example a rack and pinion type driving arrangement can equally be used.

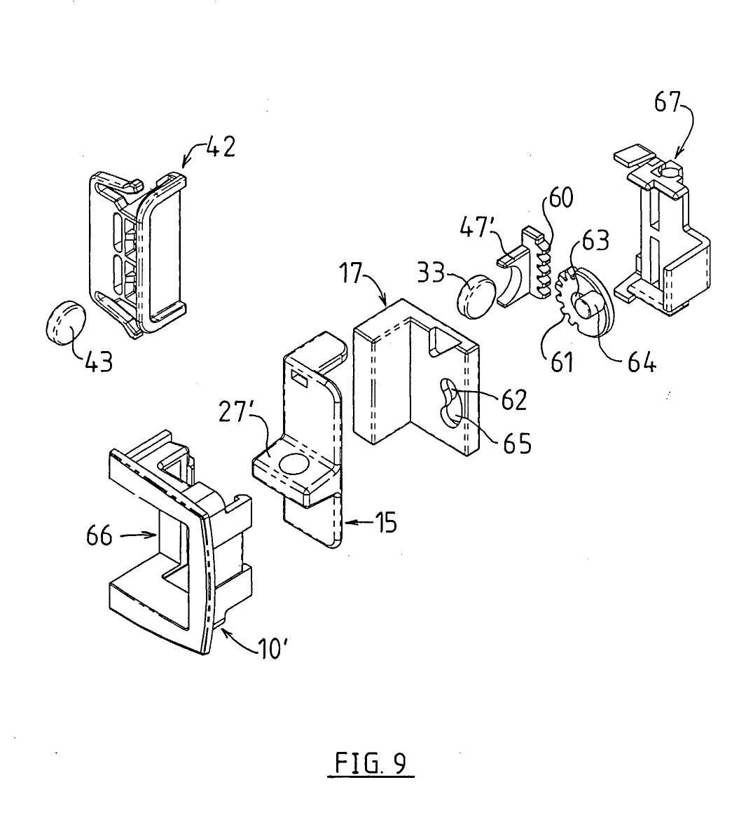

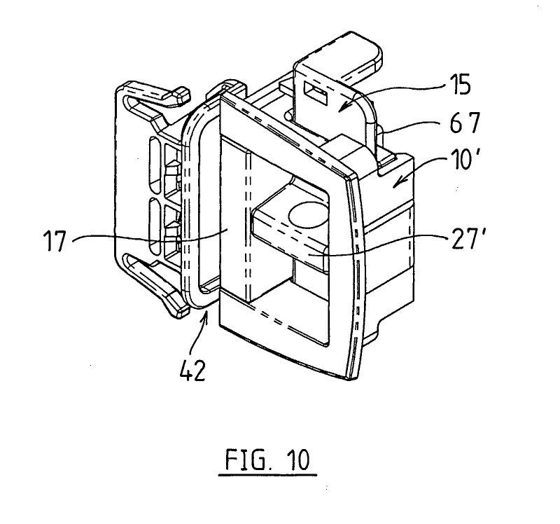

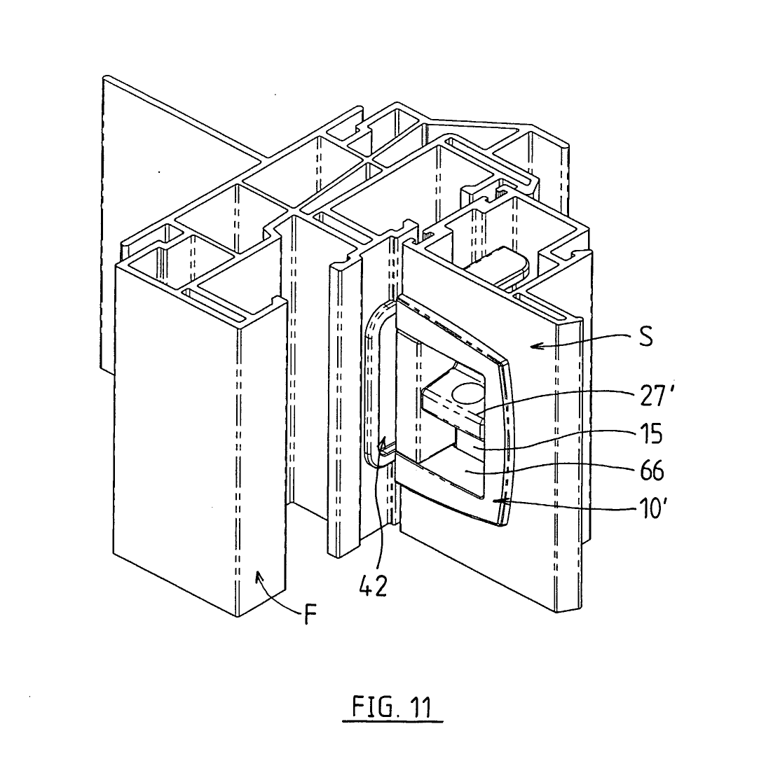

For example, FIGS. 9, 10 and 11 show a second embodiment of the invention wherein the movable magnet is moved by a rack and pinion type arrangement. In these drawings elements of construction which correspond with the first described embodiment have the same reference numerals.

According to the second embodiment the moveable magnet 33 engages with scoop 47′ which is provided with a rack 60. This rack 60 meshes with a toothed wheel 61 which is mounted for rotation by a spigot 62 projecting from the bolt 17 engaging in central opening 63 of the toothed wheel 61. A pin 64 projecting from the face of toothed wheel 61 extends through a curved slot 65 in the bolt 17.

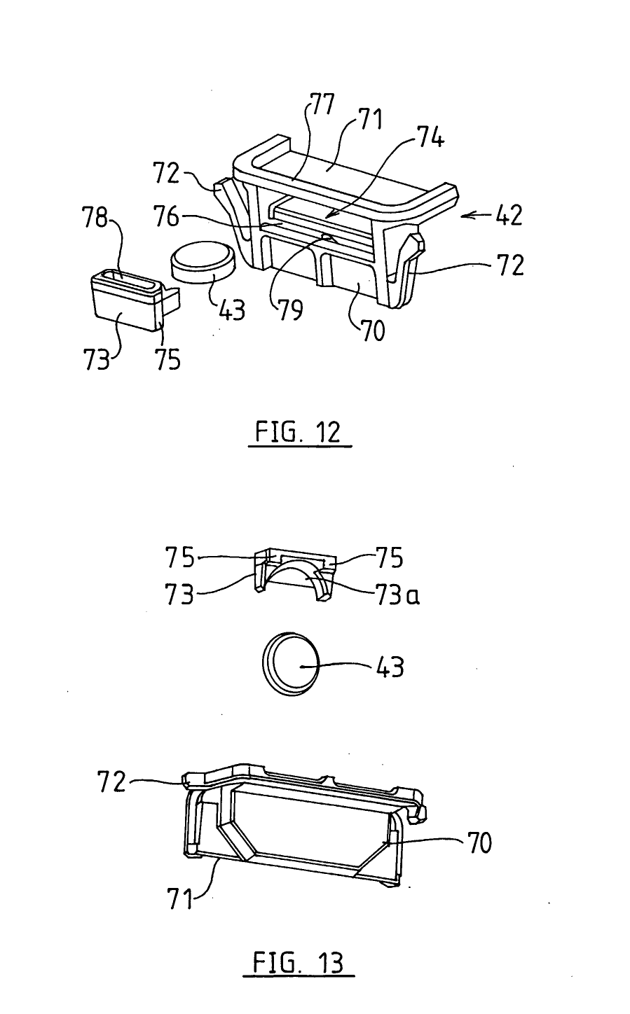

The slider 15 is slidingly engaged with a body 10′ which as can be seen from FIG. 12 engages in an aperture routed out of the sash section S. A finger engagement portion 27′ projects from the slider 15 and is accessible in a recess 66 in body 10′.

The slider 15, bolt 17, together with toothed gear wheel 61 and rack 60/scoop 47′, are held in their working relationship by a retainer element 67 which clips onto body 10′. Accordingly pin 64 engages in a profiled recess (not shown) in slider 15 so that as the slider 15 is moved rectilinearly the toothed wheel 61 is rotated. This causes the rack 60 to move which drives the moveable magnet 33 away from its alignment with fixed magnet 43 in the strike 42 in window frame section F.

Other simple or more complicated construction of an externally accessible actuator (instead of button 26) and mechanical drive between the actuator and bolt 17 are within the scope of this invention as will be readily apparent to the skilled person.

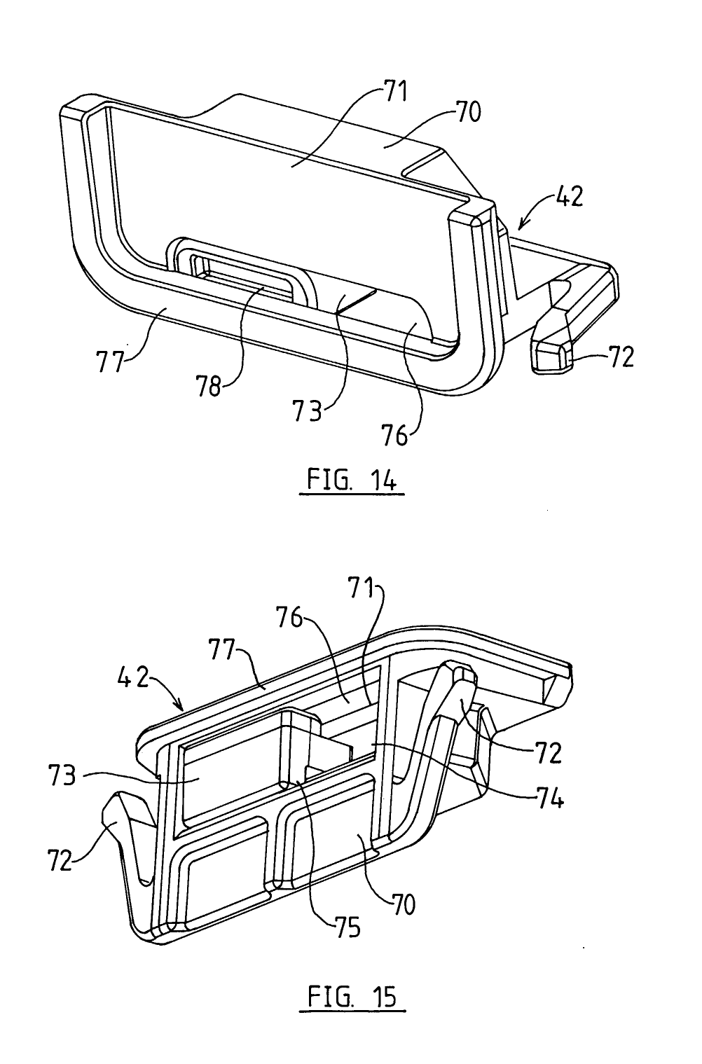

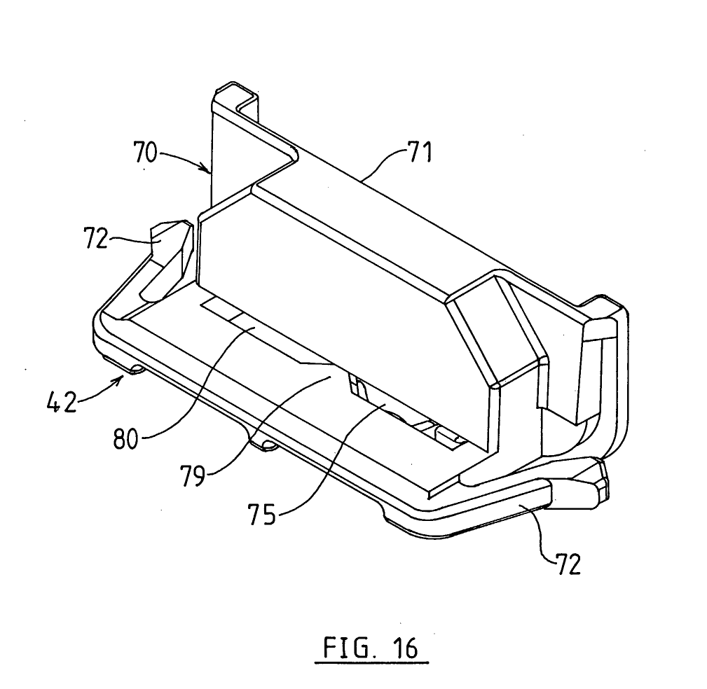

FIGS. 12 to 15 show a further form of the strike. According to the form of the strike the “handing” of the strike can be readily changed. Thus the manufacturer only needs to make one part and equally a customer only needs to stock one part.

The strike 42 is made of one principal part namely body 70, which is of moulded construction. The body 70 includes a recessed strike face 71 for engagement by the latch bolt 17. Body 70 further includes a pair of clips 72 which enable the strike to be clip fastened into an opening in the frame F.

Magnet 43 engages in pocket or recess 73a, a strike carriage 73, which in turn engages in a groove 74 in body 70. The strike carriage 73 has one or more small legs 75 that function as clips and clip into slot 80 to slidingly clip the carriage 73 into the strike 42.

A slot 76 is formed in the recessed face 71 adjacent the walled edge 77. A pocket 78 formed in the strike carriage 73 is accessible through slot 76. Thus an implement, such as a screw driver, can be engaged through slot 76 into pocket 78 so that the carriage 73 can be slid from one end of groove 74 to the other end thereby changing the strike from left hand to right hand configuration. A stop 79, in slot 80, interacts with clip legs 75 to hold the carriage in its adjusted position.

Thus by use of an implement the strike carriage can be moved to an adjusted position and held there, thus making it possible to readily alter the hand of the strike 42 after the strike has been installed in the window. The installer therefore does not need to worry about orientation at the time of installation.

Because the strike is designed to be non-removeable the handing operation is important to avoid having to damage the strike to make it correctly orientated. Costly installation mistakes are therefore eliminated.

1. (canceled)

2. (canceled)

3. The device of claim 21 wherein the magnets are permanent magnets.

4. (canceled)

5. The device as claimed in claim 21 wherein the magnet associated with the latch member is moveable.

6. (canceled)

7. The device as claimed in claim 21 wherein the latch device includes a moving devices for moving the moveable magnet.

8. The device as claimed in claim 7 wherein there is provided a retention arrangements for temporarily retaining the moveable magnet following movement thereof by the moving device.

9. The device as claimed in claim 8 further including a user accessible slider mechanism which is coupled to the moving device.

10. The device as claimed in claim 9 wherein the slider mechanism includes an engagement element to engage with the latch member and move the latch member against the biasing effect of the biasing device.

11. The device as claimed in claim 10 wherein the biasing device is a spring, which biases the latch member to the non-latching position.

12. The device as claimed in claims 9 wherein the slider mechanism includes a user accessible actuating element, which is moveable to unlatch the latch, the actuating element being moveable in the direction in which a closure element, such as a window, is moveable toward an open position.

13. The device as claimed in claims 21 wherein the device is of a construction that is attachable to the vertical side of a sliding sash of a window whereby when the sash is moved to its closed position the latch device self actuates under the action of the magnets. thereby locking the sash into the closed position.

14. The device as claimed in claim 13 in combination with a hung window sash wherein a said self latching device is attached to or mounted with each vertical side of the hung sash.

15. (canceled)

16. (canceled)

17. (canceled)

18. (canceled)

19. The window sash as claimed in claim 22 wherein one magnet is movable to a position where it is repulsed by the other magnet and thereby driven into a retainer.

20. (canceled)

21. A self latching device including a latch member moveable between a latching position and a non latching position, the latch member when in the latching position being engaged with a strike, a biasing device to bias the latch member into one of said latching and non-latching positions and magnets for moving the latch member into the other of said latching and non-latching positions, the magnets including a magnet associated with the strike and a magnet associated with the latch member, one of said magnets is fixed in position and the other is moveable, the moveable magnet being moveable in a direction transverse to the direction in which the latch member moves between the latching and non-latching positions.

22. A window sash mounted for vertical sliding movement in a frame the sash including vertical side elements in each of which is located a self latching latch device which has a latch member movable between a latching position and a non-latching position the latch member, when in the latching position, being engaged in a strike located with a portion of the frame which is adjacent the vertical side element of the sash, a biasing device to bias the latch member into one of said latching and non-latching positions, magnets for moving the latch member into engagement with the strike when the sash has moved to a position where latching of the sash is to occur, an operating element which, in use, is moveable by a person moving the sash from a latched position to effect movement of the latch member to its non-latching position, the operating element being movable in a direction which corresponds to the direction in which the sash is to move away from the latched position, the magnets include two magnets one mounted with the strike and the other with the latch member, whereby the latch member is moved into the latching position by attraction between the magnets and a moving device for causing a shearing action between the magnets to occur whereby the latch member can be moved to the non-latching position.

23. The window sash as claimed in claim 19 wherein the operating element is part of a slider mechanism operable to unlatch the latch device.

24. The window sash as claimed in claim 23 wherein the slider mechanism includes an engagement element to engage with the latch member and move the latch member against the biasing effect of the biasing device.

25. The window sash as claimed in claim 24 wherein the biasing device is a spring, which biases the latch member to a non-latching position.

26. A window sash as claimed in claim 24 wherein one of said magnets is fixed in position and the other is movable, the movable magnet being movable in a direction transverse to the direction in which the latch member moves between the latching and non-latching positions.

27. The window sash of claim 26 wherein the magnets are permanent magnets.

28. The window sash as claimed in claim 27 wherein the magnet associated with the latch member is movable.

29. The window sash as claimed in claim 28 wherein the latch device includes a moving device for moving the movable magnet.

30. The device as claimed in claim 21 wherein the strike includes a plurality of pockets or recesses into a selected one of which the magnet can be located.

31. The device as claimed in claim 30 wherein the strike is located in a carriage which is adjustably mounted in the strike.

32. The device as claimed in claim 30 wherein there is provided disengagable locating arrangement for locating the carriage in an adjusted position.

33. The device as claimed in claim 32 wherein the strike is a moulded one piece body in which the carriage is mounted, the body incorporating clips for clip mounting of the strike in an opening window frame.

34. The device as claimed in claim 7 wherein the moving device includes a rack and toothed gear drive coupling the slider mechanism to a magnet carrier.

35. The device as claimed in claim 34 wherein the toothed gear includes a spigot slidingly engaged with a curved guide of the slider mechanism to translate sliding movement of the slider mechanism into a rotary motion of the toothed gear.

36. The device as claimed in claim 7 wherein the moving device is a disk mounted for rotary movement, the disk having at least one spigot engaged with a profiled guide in the slider mechanism whereby sliding movement of the slider mechanism is translated into rotary movement of the disk.

37. The device as claimed in claim 36 wherein the disk includes a further spigot engaged in a slot in a slidingly mounted magnet pusher.

38. The device as claimed in claim 36 wherein the movable magnet is movably located in a recess into which the pusher locates whereby movement of the slider mechanism is transmitted to the pusher to move the movable magnet in the recess.

39. The device as claimed in claim 37 wherein the retainer is an angled recess communicating with the recess in which movable magnet is moved by the pusher, the angled recess being located at or near the limit of movement of the pusher.

40. The device as claimed in claim 38 wherein the slider mechanism is biased by a slider mechanism biasing device to return to the position from which it has moved to effect unlatching of the device.

41. The device as claimed in claim 32 wherein the slider mechanism biasing device is a spring.
